(19) United States
(12) Patent Application Publication
(10) Pub. No.: US 2026/0023186 A1
(43) Pub. Date: Jan. 22, 2026

(54) MEASURING STRUCTURE FOR PET AND SPECT APPLICATIONS

(71) Applicant: CONSIGLIO NAZIONALE DELLE RICERCHE, Rome (IT)

(72) Inventors: Alessandro SOLURI, Rome (IT); Roberto MASSARI, Nettuno (RM) (IT)

(21) Appl. No.: 18/998,047

(22) PCT Filed: Jul. 24, 2023
(86) PCT No.: PCT/IB2023/057490

§ 371 Date: Jan. 23, 2025

(30) Foreign Application Priority Data
Jul. 26, 2022 (IT) 102022000015708

(51) Int. Cl. G01T 1/164; G01T 1/202; G01T 1/208; G01T 1/29

(52) U.S. Cl. CPC G01T 1/1644; G01T 1/202; G01T 1/208; G01T 1/2985

(57) ABSTRACT

Described is a measuring structure (100) for PET or SPECT applications comprising a matrix of scintillation crystals (200) configured for simultaneously measuring radiation directed along respective directions. each crystal (200) extending along a longitudinal axis (X) between an upper surface (200a) and a base surface (200b) opposite the upper surface (200a), each scintillation crystal (200) having, along the longitudinal axis (X), a variable transversal section. The structure also comprises a grille (300) defining a plurality of through seats each configured for receiving a respective scintillation crystal (200). Each seat has inner walls (301) shaped to match a lateral surface of the respective scintillation crystal (200). The grille (300) is made of a metal material with a high atomic number designed to screen incident radiation.

This invention relates to a measuring structure of the type present in diagnostic imaging devices for PET or SPECT analyses used for locating lymph nodes, tumours and/or other diseases.

Currently, a radiopharmaceutical is administered to a patient in order to locate diseases such as those listed above. This radiopharmaceutical tends to concentrate precisely in the cells affected by these diseases, defining it as a “source” of radiation.

As is known, the imaging devices use the conversion of the energy of the photons of the incident radiation into light in such a way that the latter can be “collected” by electronic devices such as, for example, photodiodes or phototubes.

The prior art imaging devices are substantially formed by a scintillation structure, one or more photomultiplicators and, if necessary, a collimator.

In more detail, the photomultiplicator is connected to the scintillation structure by means of a suitable optical connection and its purpose is to detect the luminous photons of the incident radiation transforming their energy into an electrical signal which is amplified and carried towards the processing circuits to recreate the image of the radiation source, that is to say, of the zone affected by disease.

The collimator, on the other hand, if present, is positioned between the source which emits radiation and the scintillation structure and has the purpose of allowing the passage of only the radiation directed perpendicularly to the scintillation structure, screening all the radiation directed in different directions.

In order to improve the intrinsic spatial resolution of the imaging devices, measuring structures have been developed which comprise a plurality of scintillation crystals positioned side by side to form a matrix of crystals.

There are prior art matrix structures, that is to say, structures wherein individual rod-shaped crystals are locked by means of epoxy resins, the purpose of which is to keep the crystals mutually connected and equidistant in a metal grille. In this situation, the radiation emitted strikes only the face of the crystal uncovered whilst the other faces contribute to conveying the radiation towards the photomultiplicator in such a way as to be able to obtain, by processing the radiation signals, an image relative to the zone affected by the disease.

In fact, during PET or SPECT type analyses, the radiopharmaceutical emits radiation in different directions, some of which intercept the crystals causing an impact of the photons on them at respective scintillation points.

In this situation, a same photon can produce several scintillation points in crystals close to each other giving rise to a series of events which result in an incorrect reconstruction of the image of the zone affected by disease.

Generally speaking, the fact that one or more photons produce scintillation points between crystals adjacent to that struck by the incident radiation results in an incorrect calculation of the position of the interaction of the photon, thus obtaining a false image of the zone affected by disease.

It is therefore known that, in the physical processes which contribute to the formation of the scintigraphic images, unwanted interactions may occur, such as, for example, Compton or scattering interactions, between the photons incident on the matrix of crystals which are able to degrade the quality of the image.

More specifically, in the case of SPECT applications with emissions of single photons, this aspect is largely resolved with the use of collimators which filter the passage of the angled photons which come from the body but, disadvantageously, they cannot prevent the passage of those photons which pass through the holes of the collimator after having undergone scattering inside the body and which arrive at right angles on the detector.

In the case of PET applications, on the other hand, the real position of first interaction of the photons which interact in the crystal is not always correctly identified, thus falsifying the counting statistics as well as the final image of the zone affected by disease.

In other words, a problem particularly felt is that relative to the Compton effects which arise between nearby crystals and that relative to the photons which arrive with in an angled manner on the crystal relative to the direction at a right angle to the surface of the crystal, contributing to a distribution of false events relative to that which should correspond to the image representing the zone affected by disease.

The technical purpose of the invention is therefore to provide a measuring structure which is able to overcome the drawbacks of the prior art.

The aim of the invention is therefore to provide a measuring structure which has a better spatial resolution.

A further aim of the invention is to provide a measuring structure which can be used both for the SPECT and for the PET techniques.

A further aim of the invention is to provide a measuring structure which is able to improve the diagnostic performance in terms of contrast of the images and, in general, optimise the diagnostic information.

A further aim of the invention is to provide a measuring structure which is able to limit events which are not useful for forming the image thus contributing to the exclusive selection of the events valid for forming the scintigraphic image.

The technical purpose indicated and the aims specified are substantially achieved by a measuring structure comprising the technical features described in one or more of the accompanying claims. The dependent claims correspond to possible embodiments of the invention.

Further features and advantages of the invention are more apparent in the non-limiting description which follows of a non-exclusive embodiment of a measuring structure.

The description is set out below with reference to the accompanying drawings which are provided solely for purposes of illustration without restricting the scope of the invention and in which:

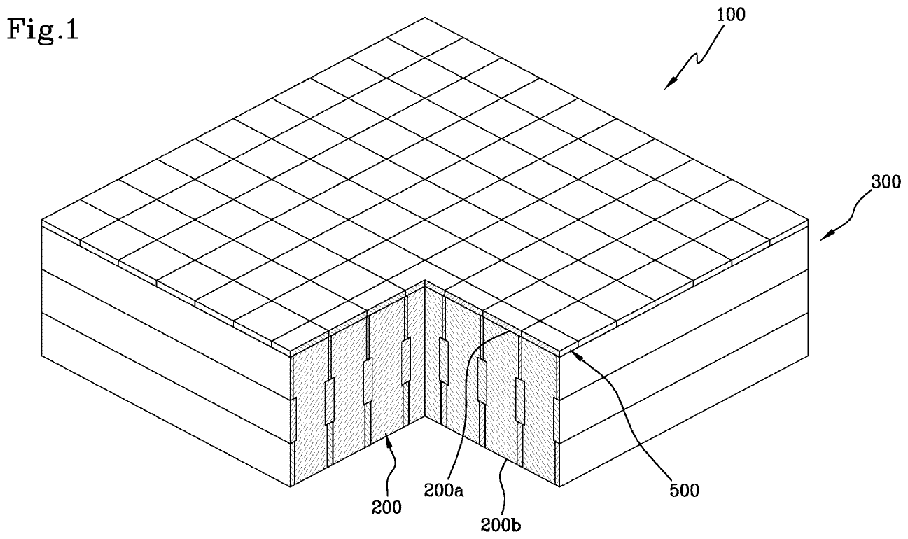

FIG. 1 is a perspective view of a measuring structure according to the invention;

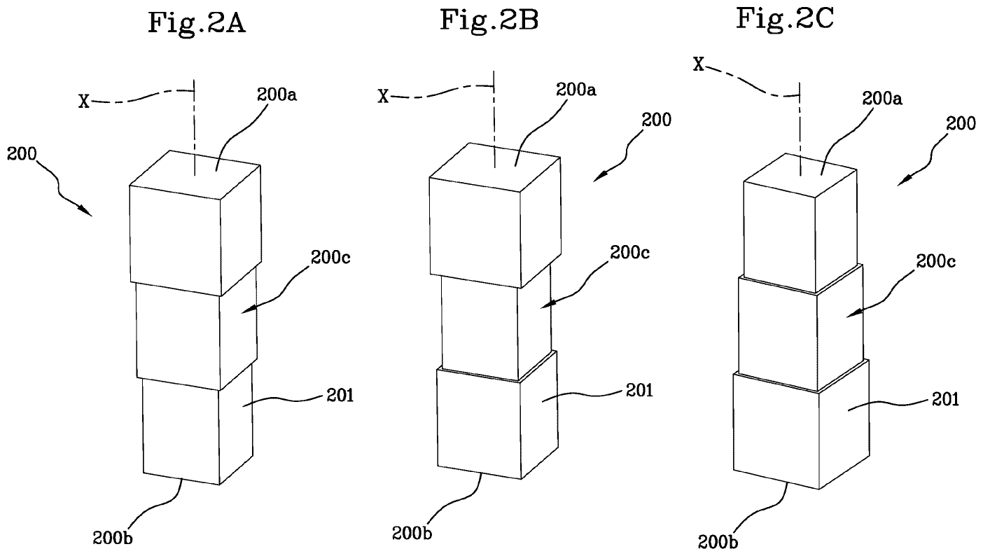

FIGS. 2A-2C show different embodiments of crystals of the measuring structure;

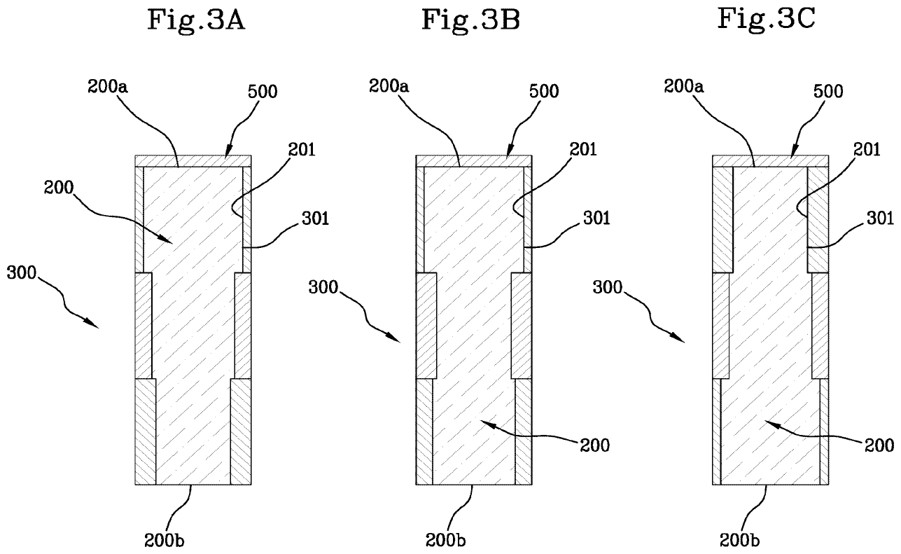

FIGS. 3A-3C are cross sections of the respective crystals of FIGS. 2A-2C inserted in a grille;

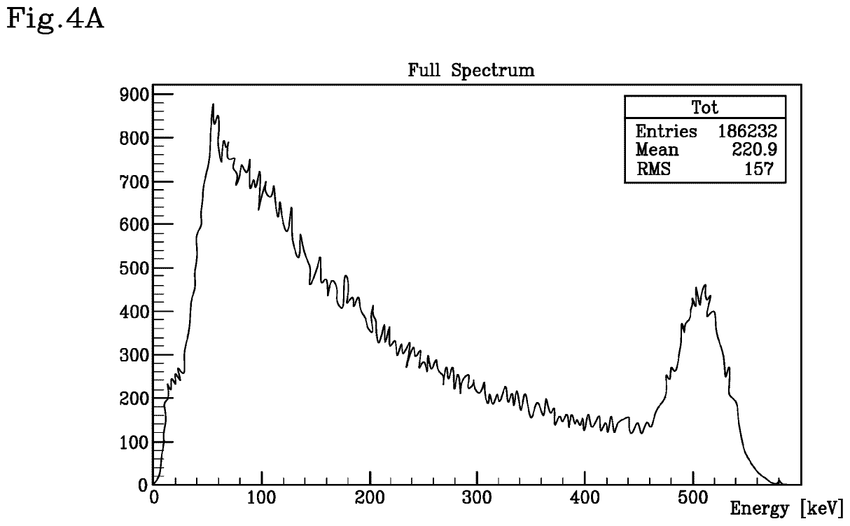

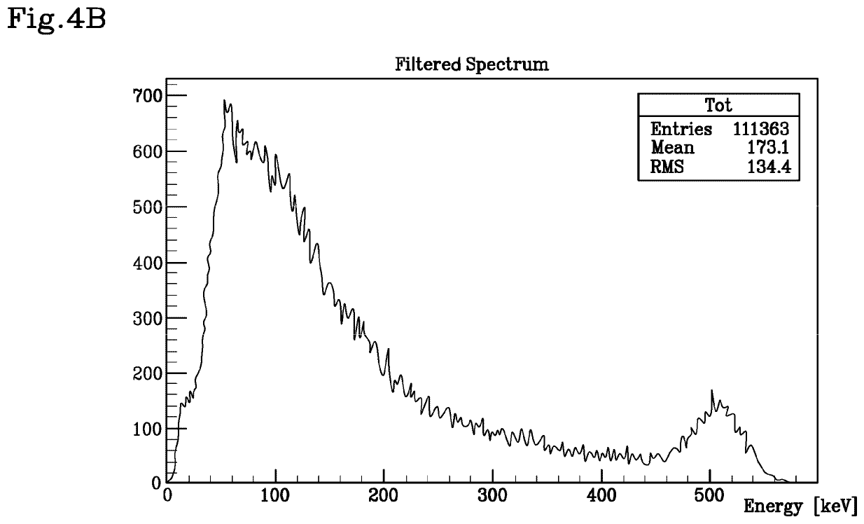

FIGS. 4A-4B show two graphs representing the radiation striking the measuring structure.

With reference to the accompanying drawings, the numeral 100 denotes a measuring structure 100 for PET or SPECT applications.

The measuring structure 100 comprises a matrix of scintillation crystals 200 configured for simultaneously measuring direct radiation along respective directions.

According to a possible embodiment, the scintillation crystals 200 of the matrix are hygroscopic crystals such as, for example: Sodium iodide (NaI(Tl)), lanthanum chloride (LaCl3:Ce) and lanthanum bromide (LaBr3:Ce) and the like.

Alternatively, the scintillation crystals 200 of the matrix are non-hygroscopic crystals such as, for example: LYSO, LSO, GSO and the like.

Each scintillation crystal 200 extends along a longitudinal axis “X” between an upper surface 200a and a base surface 200b opposite the upper surface 200a.

According to the embodiment illustrated, the scintillation crystals 200 have, in cross section, a substantially square shape.

Alternatively, the scintillation crystals 200 might have, in cross section, any polygonal shape.

As shown by way of example in FIGS. 2A-2C, each scintillation crystal 200 has, along the longitudinal axis “X”, a variable transversal section.

In particular, each scintillation crystal 200 has, along the longitudinal axis “X”, a transversal section variable in terms of dimensions.

Preferably, the maximum cross-section of the scintillation crystals 200 is between 5 and 40 mm² and more preferably between 8 and 20 mm².

Preferably, the minimum cross section of the scintillation crystals 200 is between 3 and 20 mm² and more preferably between 5 and 14 mm².

Advantageously, the above-mentioned dimensions allow the scintillation crystals 200 to absorb both a photoelectric event given by the incident radiation and any Compton interactions.

In accordance with the embodiment shown in FIG. 2A, the scintillation crystals 200 of the matrix may have a tapered shape, along the longitudinal axis “X”, from the upper surface 200a to the base surface 200b.

In other words, the scintillation crystals 200 of the matrix may have a decreasing transversal section from the upper surface 200a to the base surface 200b.

Alternatively, as shown in FIG. 2C, the scintillation crystals 200 of the matrix may have an opposite shape relative to the previous one, therefore tapered, along the longitudinal axis “X”, from the base surface 200b to the upper surface 200a.

In other words, the scintillation crystals 200 of the matrix may have a decreasing transversal section from the base surface 200b to the upper surface 200a.

Alternatively, as shown in FIG. 2B, the scintillation crystals 200 of the matrix may have a transversal section decreasing, from both sides, along the longitudinal axis “X”, from each of the upper surface 200a and base surface 200b towards a central zone 200c of the scintillation crystal 200 between the upper surface 200a and the base surface 200b, preferably with a symmetrical shape about a transversal mid-plane.

Again with reference to the embodiment shown in FIG. 2B, each scintillation crystal 200 has a first end stretch defining the upper surface 200a and a second end stretch defining the base surface 200b. In this situation, as shown in FIG. 3B, the first end stretch has a different transversal section, preferably greater, than the second end stretch.

Preferably, in this situation, as shown in FIG. 2B, each scintillation crystal 200 has a central stretch with a minimum and preferably constant transversal section.

In other words, the scintillation crystals 200 of the matrix may have a narrowing of the transversal section substantially in the proximity of their central zone 200c.

The central stretch with a minimum transversal section extends for a length, along the longitudinal axis “X”, greater than 50%, preferably greater than 60%, of the length of the scintillation crystal 200.

Even more preferably, the central stretch with a minimum transversal section extends for a length, along the longitudinal axis “X”, less than 50%, preferably less than 40%, of the length of the scintillation crystal 200.

In other words, according to the embodiment shown in FIGS. 2B and 3B, the scintillation crystal 200 has, starting from the upper surface 200a and descending along the longitudinal axis “X” towards the base surface 200b, a first stretch having a first transversal dimension, a central stretch having a third transversal dimension less than the first transversal dimension and a second stretch having a second transversal dimension less than the first transversal dimension but greater than the third transversal dimension.

Generalising, therefore, as further shown also in FIGS. 3A-3C, each scintillation crystal 200 has, along a cross-section passing through the longitudinal axis “X”, a stepped profile.

In this situation, each scintillation crystal 200 is structured as a single structure having, along the longitudinal axis “X”, scintillation “blocks” having dimensions of the transversal section different to each other.

In other words, each scintillation crystal 200 is shaped along the longitudinal axis “X” in such a way as to have one or more variations in the dimensions of the transversal section.

Advantageously, the shape described above makes it possible to obtain a trend of the attenuation of the photons as a function of the angle with which they arrive.

In other words, the shape described above makes it possible to screen the radiation having an angle which is not suitable for forming the image of the zone affected by disease.

Advantageously, the shape described above makes it possible to attenuate significantly the so-called cross-talk between nearby scintillation crystals 200.

The measuring structure 100 also comprises an electronic conversion circuitry configured for receiving an optical signal from each scintillation crystal 200 and converting it into an electrical signal. In this situation, the electrical signals are then processed in such a way as to obtain an image representing the zone affected by the disease.

Preferably, the conversion electronics are operatively applied to the base surfaces 200b of the scintillation crystals 200 in such a way as to receive the signals deriving from each of the scintillation crystals 200.

As shown in the accompanying drawings, the measuring structure 100 also comprises a grille 300 defining a plurality of through seats each configured for receiving a respective scintillation crystal 200.

Preferably, the grille 300 comprises a plurality of plates each equipped with a series of notches configured to allow a comb-like coupling of one plate with the other in such a way as to form the plurality of seats for receiving the scintillation crystals 200.

The grille 300 is made of metal material, for example tungsten or tungsten or platinum alloys, with a high atomic number suitable for screening the incident radiation.

Preferably, the grille 300 is coated with an absorbent material. For example, the grille 300 may be treated by applying layers of other metals which are able to absorb lateral events and divert the diffusion between nearby crystals.

As shown in the cross sections of FIGS. 3A-3C, each seat has inner walls 301 shaped to match a lateral surface 201 of the respective scintillation crystal 200.

According to the embodiment illustrated in the accompanying drawings, the grille 300 comprises three half-grilles each having a plurality of holes of different sizes. In this situation, the half-grilles are positioned one above the other in such a way that the holes define suitably shaped through seats.

Alternatively, the grille 300 is made in a single piece wherein each seat is suitably shaped by machining.

Preferably, the grille 300 has, along the longitudinal axis “X”, variable thicknesses and in particular substantially complementary to the variation of the transversal section of the scintillation crystals 200.

Even more preferably, as also shown in the cross-section views of FIGS. 3A-3C, the inner wall 301 of each seat has, along the longitudinal axis “X”, thicknesses variable and substantially complementary to the variation of the transversal section of the scintillation crystal inserted therein. In this situation, the distance between opposite outer walls of each seat remains unchanged and equal to that of the other seats of the grille 300 (as shown in FIG. 1) whilst the distance between an outer wall and the corresponding inner wall (that is to say, the thickness) varies according to the trend of the cross-section of the scintillation crystal 200.

If, for example, a distance of 5 mm is to be maintained between opposite outer walls of each seat and the scintillation crystal 200 to be inserted is made in accordance with the shape shown in FIG. 3B and has, starting from the upper surface 200a, the first stretch with a transversal section of 4×4 mm, the central stretch with a transversal section of 2×2 mm and the second stretch with a transversal section 3×3 mm, the wall of the seat will have a thickness (that is to say, the distance between the outer wall and the corresponding inner wall) variable along the longitudinal axis “X” and equal, respectively, to 1 mm, 3 mm, 2 mm.

The lateral surface 201 of each scintillation crystal 200 is therefore wrapped or covered by the metallic layer defined by the inner wall 301 of the seat of the grille 300.

In this way, in use, the collection of the radiation occurs through the base surface 200b of each scintillation crystal 200 which, being connected to the conversion electronics, collects the light signals produced during the scintillation. On the other hand, the other surfaces of the scintillation crystal 200, as they surrounded by the inner wall 301 of the seat, prevent the radiation from exiting in such a way as to convey it towards the conversion electronics.

The light produced inside each scintillation crystal 200 is proportional to the energy of the incident photon and it is therefore possible, from this information, to obtain the actual energy of the photon which has interacted with the scintillation crystal 200 obtaining, by processing the electrical signals, an image representing the zone affected by the disease.

According to an aspect of the invention, the measuring structure 100 also comprises a filter 500 applied to the upper surface 200a of the scintillation crystals 200 and configured for absorbing radiation having energy less than a predetermined value.

When the radiation strikes the measuring structure 100, Compton events occur in the measuring structure 100 which can potentially distort the signal acquired for forming the image of the zone affected by the disease.

By using the filter 500 it is, on the other hand, possible to clean the signal of non-useful contributions for the formation of the image in such a way as to information with a greater contrast both in SPECT and PET techniques.

In particular, as shown in FIGS. 4A and 4B, the filter 500 allows elimination of the contributions and the disturbances (see the peak on the right in FIG. 4A which is dampened by the action of the filter 500 as shown in FIG. 4B) caused by the Compton effect.

Advantageously, the reduction in these contributions may also affect the overall measurement time for forming a detailed scintigraphic image, reducing it and therefore making the obtaining of the image faster.

Preferably, the filter 500 is of the multi-layer type.

Even more preferably, the filter 500 is a multi-layer wherein at least one layer is made of metallic material and at least one layer is made of a material with a low density.

The metallic material can be selected from: copper, tungsten, gadolinium, yttrium, aluminium lead, bismuth, tin and brass.

These materials allow a selective filtration, that is to say, they only allow some energy of the incident photons to be filtered, in such a way as to not reduce too much the overall measuring efficiency of the entire measuring structure 100.

By way of a non-limiting example, depending on the metal material selected for making the filter 500, it is possible to filter low energy events (for example up to 80%-90% of the events under 100 keV) with respect to events with a higher energy, for which the attenuation percentage of the filter 500 is reduced (for example up to 30% of the events above 400 keV).

The use of a multi-layer filter 500, where various metallic materials are located in a suitable sequence, therefore allows the phenomena of fluorescence to be reduced, which could be produced during the various interactions of the measuring structure 100 with the photons of the radiation.

Advantageously, the reduction in the number of photons which are absorbed by the scintillation crystals 200 due to the filter 500 affects the total number of events measured in the spectrum useful for generating the image, favouring the acquisition of the images with lower rates but, at the same time, also affecting the processing times.

Advantageously, it is therefore possible to have a better selection of the events due to the Compton effect inside the measuring crystals 200 and a better contrast on the image produced.

The invention achieves the preset aims eliminating the drawbacks of the prior art. In particular, the invention makes it possible to limit events which are not useful for forming the image of the zone affected by the disease, thus selecting only the valid events.

The variation of the cross-section dimension of the scintillation crystals 200 makes it possible to improve the diagnostic performance in terms of contrast of the images and, in general, optimise the diagnostic information.

The presence of the filter 500 allows elimination of the contributions and the disturbances caused by the Compton effect inside the scintillation crystals 200.

1. A measuring structure (100) for PET or SPECT applications comprising:
a matrix of scintillation crystals (200) configured for simultaneously measuring radiation directed along respective directions, each crystal (200) extending along a longitudinal axis (X) between an upper surface (200a) and a base surface (200b) opposite the upper surface (200a), each scintillation crystal (200) having, along the longitudinal axis (X), a variable transversal section;
a grille (300) defining a plurality of through seats each configured for receiving a respective scintillation crystal (200), each seat having inner walls (301) shaped to match a lateral surface (201) of the respective scintillation crystal (200), said grille (300) being made of a metallic material with a high atomic number designed to screen incident radiation;
an electronic conversion circuitry configured for receiving an optical signal from each scintillation crystal (200) and converting it into an electrical signal;
characterised in that each scintillation crystal (200) has, in a section passing through the longitudinal axis (X), a step profile.

2. The structure according to claim 1, wherein each scintillation crystal (200) has a tapered shape, along said longitudinal axis (X), from the upper surface (200a) to the base surface (200b).

3. The structure according to claim 1, wherein each scintillation crystal (200) has a tapered shape, along said longitudinal axis (X), from the base surface (200b) to the upper surface (200a).

4. The structure according to claim 1, wherein each scintillation crystal (200) has a transversal section decreasing, along said longitudinal axis (X), between each of said upper surface (200a) and base surface (200b) and a central zone (200c) of the scintillation crystal (200) between said upper surface (200a) and base surface (200b).

5. The structure according to claim 4, wherein each scintillation crystal (200) comprises a first end stretch defining said upper surface (200a) and a second end stretch defining said base surface (200b), and wherein said first end stretch has a transversal cross section which is different to, preferably greater than, said second end stretch.

6. The structure according to claim 4, wherein each scintillation crystal (200) has a central stretch with a minimum transversal section and preferably constant, and wherein said central stretch with a minimum transversal section extends for a length, along the longitudinal axis (X), greater than 50%, preferably greater than 60%, of the length of the scintillation crystal (200).

7. The structure according to claim 4, wherein each scintillation crystal (200) has a central stretch with a minimum transversal section and preferably constant, and wherein said central stretch with a minimum transversal section extends for a length, along the longitudinal axis (X), less than 50%, preferably less than 40%, of the length of the scintillation crystal (200).

8. The structure according to claim 1, wherein the maximum section of said scintillation crystals (200) is between 5 and 40 mm², and preferably between 8 and 20 mm², and wherein the minimum section of said scintillation crystals (200) is between 3 and 20 mm², and preferably between 5 and 14 mm².

9. The structure according to claim 1, wherein said grille (300) has, along the longitudinal axis (X), variable thicknesses substantially complementary to the variation in transversal section of the scintillation crystals (200).

10. The structure according to claim 1, comprising a filter (500) applied to the upper surface (200a) of the scintillation crystals (200) and configured to absorb the radiation having energy less than a predetermined value.

11. The structure according to claim 10, wherein said filter (500) is of the multilayer type, preferably said filter (500) being a multilayer wherein at least one layer is made of metallic material and at least one layer is made of a material with a low density, preferably said metallic material being selected between: copper, tungsten, gadolinium, yttrium, lead aluminium, bismuth, tin and brass.

12. The structure according to claim 1, wherein each step of the step profile has a wall parallel to the longitudinal axis (X).

13. The structure according to claim 12, wherein each scintillation crystal (200) is formed as a single structure having, along the longitudinal axis (X), scintillation blocks having a dimension, in transversal cross-section, different to each other.
